(19) United States
(12) Patent Application Publication
(10) Pub. No.: US 2010/0218115 A1
(43) Pub. Date: Aug. 26, 2010

(54) ENHANCED USER INTERFACE FOR CURRENCY TRADING

(75) Inventors: Michael Ross Curtin, Highland, UT (US); Todd Benjamin Crosland, Salt Lake City, UT (US); Nathan Laurence Muirbrook, Saratoga Springs, UT (US)

Correspondence Address: Workman Nydegger;1000 Eagle Gate Tower, 60 East South Temple, Salt Lake City, UT, 84111, US

(73) Assignee: Interbank FX, LLC, Salt Lake City, UT (US)

(21) Appl. No.: 12/390,189

(22) Filed: Feb. 20, 2009

(51) Int. Cl. G06F 3/048; G06Q 40/00

(52) U.S. Cl. 715/747; 705/36 R; 715/769; 715/781

(57) ABSTRACT

The present invention relates to systems, methods, and computer program products for docking a currency pair user interface element to a corresponding chart. One or more currency pair user interface elements are generated that include real time price data for a currency pair and buy and sell functionality. A chart corresponding to one of the currency pair user interface elements and including historical trading data is also generated. The chart includes a link configured to dock a currency pair user interface element to the chart. A user selects the currency pair user interface element corresponding to the chart. The currency pair user interface element is docked at the location of the link. As a result, the currency pair user interface element is displayed in the chart and becomes part of the chart so that it moves with the chart when the chart is moved.

### BACKGROUND

Our world consists of several national currencies and as individuals or companies from one country trade across borders, the need for foreign currency arises. The foreign exchange market plays a key role in transferring financial payments across borders and moving funds and purchasing power from one currency to another. The movement of different currencies between countries determines a very important price: the exchange rate. It is the exchange rate that allows the currencies to be traded for profit. The foreign exchange is not a physical exchange, but an electronic structure.

Virtually all large institutions and professional traders conduct most of their foreign exchange dealing in the (spot) FOREX market. The (spot) FOREX market pairs together currencies from different countries and quotes them according to the values of the respective currency. In the example of one common current pair, EUR/USD, the First Currency (EUR-Euro) is known as the Base Currency. It shows how much the Base Currency is worth as measured against the Second Currency (USD—US Dollar). For example, if the EUR/USD rate equals 0.9762, then one Euro is worth 0.9762 US Dollar. If a trader believes that the US Dollar will rise in relation to the Euro, the trader would sell EUR/USD. That is, sell the Euro and buy the US Dollar.

In recent years, the (spot) FOREX market has migrated to electronic trading. Electronic trading allows a trader to more quickly and easily access real-time data about various currency pairs and then to make trades based on this information. Several electronic trading platforms are available that show the trader the real-time data in an easily understood format and allow the trader to buy and sell the currency pairs at desired times. As can be appreciated, the trader must make appropriate entry and exit decisions quickly to maximize profits while minimizing losses.

Although existing electronic trading platforms offer a trader real-time price data about the currency pairs, several trading issues still exist. For example, a typical currency pair will have its price information, which is generally determined by various banking institutions, change several times a second. Thus the trader must vigilantly monitor the currency pair's price information so that he or she does not miss a desired buy and/or sell price. This becomes increasing difficult if the trader desires to track more than one currency pair at a time. Since each currency pair will have its own real time price information, the trader may be bombarded with a vast of amount of information. The trader can be easily overwhelmed by this vast amount of available information.

To help traders manage the vast amount of data they have access to, some electronic trading platforms allow a trader to group selected currency pairs together in a listing at one location on a user interface so that the trader can view the real time data in a convenient way. In addition, these electronic trading platforms allow the user to create charts for the selected currency pairs that include historical and other information about the currency pairs. These tools are designed to help the traders quickly and efficiency trade the currency pairs.

These tools, however, have several limitations. For example, a trader may desire to track several currency pairs at the same time. Accordingly, he or she may create an element in the platform that shows the real time data and a chart as previously described. That is, if the trader creates five charts and five elements showing the real time data, the trader must go back and forth between the portion of the user interface that includes the chart and the portion that includes the real time price data. As can be appreciated, since the real time price data is changing so rapidly, any time it takes to go back and forth between the real time price data and the chart may result in the trader missing a desired buy or sell price.

Another problem is that it has recently become common for a trader to use multiple computer monitors with the electronic trading platforms. The use of multiple monitors, sometime as many as 16 or 20, allow the user to place a chart for each desired currency pair in its own viewing space. Thus, distributing the user interface across multiple computer monitors provides for an efficient way to organize information about a given currency pair. However, the trader must still go between the monitor containing the real time data and whichever chart he or she is interested in. As previously mentioned, this may cause the trader to miss out on desired prices.

Likewise, the trader, if he or she does not have multiple monitors or for other desired reasons, may decide to stack the various charts on top of each other in the user interface. Again, while this may provide for an efficient way to organize information about a given currency pair, the trader may still miss out on desired prices when having to move between the stacks of charts and the portion of the user interface showing the real time data.

Some electronic trading platforms have attempted to solve some of the above mentioned problems by allowing the real time price data for a given currency pair to be placed on a corresponding chart, usually as a trading widget. While this provides some help to the trader, it also creates other problems. For instance, no current trading platform ties the real time data to the chart. Thus, if the trader moves a chart from one portion of the user interface to another or from one monitor to another, the real time information will stay behind. As can be appreciated, this may lead to a situation where the trader is unable to determine which chart corresponds to which real time data. For situations where the trader is using a large number of monitors, the user interface may soon become full of clutter from the untied data.

In addition, when moving the real time data to the charts, current platforms do not allow the information to remain in the listing of real time data. As can be appreciated, there may still be situations where a trader desires to view all the currency pair real time information even when creating the individual charts. For instance, if the trader were using multiple monitors each having a single chart, it would advantageous to have one location that still included all of the real time data to prevent the trader from having to find a particular chart if he or she desired to quickly access data about a currency pair. Thus, with current platforms the trader must choose between associating the real time price data with the various charts or having a listing of all the real time price data in one convenient location.

Accordingly, what is needed in the art is a system and method that allow real time currency pair price data to be tied to a corresponding chart so that whenever the chart is moved the real time data is also moved while still providing a listing of all the real time price data in one convenient location.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments disclosed herein relate to a methods, systems and computer program products for customizing a user interface so that a currency pair user interface element is tied to a corresponding chart representing historical data for a currency pair. The method may be performed in a computer system comprising a user interface distributed across one or more computer monitors. The method includes an act of displaying in a first portion of a user interface currency pair user interface elements corresponding to currency pairs available for currency trading. The currency pair user interface elements may include real time data indicative of the current buy price and sell price for the corresponding currency pair. The currency pair user interface elements are also configured so that a user may purchase or sell the corresponding currency pairs in substantially real time using the currency pair user interface elements.

The method also includes act of displaying in a second portion of the user interface a chart including data indicative of historical trading data regarding a particular currency pair. The chart may include one or more predefined locations including a link that is configured to dock the currency pair user interface element corresponding to the particular one currency pair to the chart.

The method also includes an act of receiving user input that selects the currency pair user interface element corresponding to the displayed chart and an act of docking the selected currency pair user interface element at one of the predefined locations.

In response to docking, in some embodiments the selected currency pair user interface element is displayed in the chart at the predefined location. In other embodiments, the selected currency pair user interface element is also concurrently displayed at the first portion of the user interface. The currency pair user interface element displayed in the chart is tied to the chart such that when the chart is moved to other portions of the user interface the currency pair user interface element remains a part of the chart at the predefined location. This results in the real time data for the currency pair moving with the historical data wherever the chart is moved within the user interface.

In further embodiments the chart and the docked selected currency pair user interface element may move between multiple monitors of the computing system while maintaining the selected currency pair user interface element as part of the chart. A user or trader may then perform buy and sell transactions in selected currency pair user interface element without the need to access or view any other part of the user interface.

Additional features and advantages will be set forth in the description which follows, and in part will be obvious from the description, or may be learned by the practice of the teaching herein. The features and advantages of the teaching herein may be realized and obtained by means of the instruments and combinations particularly pointed out in the appended claims. These and other features will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an exemplary environment and system for docking a currency pair user interface to a chart in accordance embodiments of the invention;

FIG. 2 illustrates a user interface in accordance with the embodiments of the invention;

FIGS. 3A-3C illustrate docking a currency pair user interface to a chart in accordance with embodiments of the invention;

FIGS. 4A-4B illustrate docking a currency pair user interface to a chart in accordance with embodiments of the invention;

FIGS. 5A-5C illustrate moving a chart that includes a docked currency pair user interface element in a stack of charts in accordance with embodiments of the invention;

FIGS. 6A-6D illustrate moving a chart that includes a docked currency pair user interface element between computer monitors in accordance with embodiments of the invention;

FIGS. 7A-7C illustrate undocking a currency pair user interface from a chart in accordance with embodiments of the invention;

FIG. 8 illustrates a method for customizing a user interface so that a currency pair user interface element is tied to a corresponding chart in accordance with embodiments of the invention; and

FIG. 9 illustrates an exemplary system that provides a suitable operating environment for the present invention.

### DETAILED DESCRIPTION

The present invention extends to methods, systems, and computer program products for docking a currency pair user interface element to a chart. In some embodiments, a computing system receives real time buy and sell price data for various currency pairs from multiple banks. The best buy price data and the best sell price data are combined are combined for the currency pairs.

The computing system then generates currency pair user interface elements. These elements include real time buy and sell price data for the currency pairs. The currency pair user interface elements also may be used to perform buy and sell transactions for the currency pair. Thus, a currency pair trader may view the currency pair user interface elements to see real time price data and may use the elements to buy and sell the currency pairs.

The computing system also generates charts for each currency pair. The charts include historical trading data that allows the trader a quick view of the price trends of the currency pair. The computing system may generate a link at one or more predetermined locations. The link is configured to dock a currency pair user interface element to the chart.

As will be discussed, it is advantageous to tie a currency pair user interface element to its corresponding chart. Accordingly, the computing system allows the trader to select the currency pair user interface element corresponding to a chart this being displayed. The computing system will then dock the selected currency pair user interface element to the chart. As a result, the currency pair user interface element becomes part of the chart and moves with chart when the chart is moved from one part of a user interface to another such as form one computer monitor to another or when the chart is moved in a stack of charts. The trader is then able to view the real time price data and to perform buy and/or sell transactions directly in the docked currency pair user interface element without the need to access or view a currency pair user interface element located at a different part of the user interface.

In one embodiment, a trader or user uses a mouse cursor to select the currency pair user interface element. The selected currency pair user interface element is then dragged to the link and dropped on the link. This results in the currency pair user interface element being tied to the chart.

In another embodiment, the trader uses the mouse cursor to click on the link. This causes the selected currency pair user interface element to be tied to the chart.

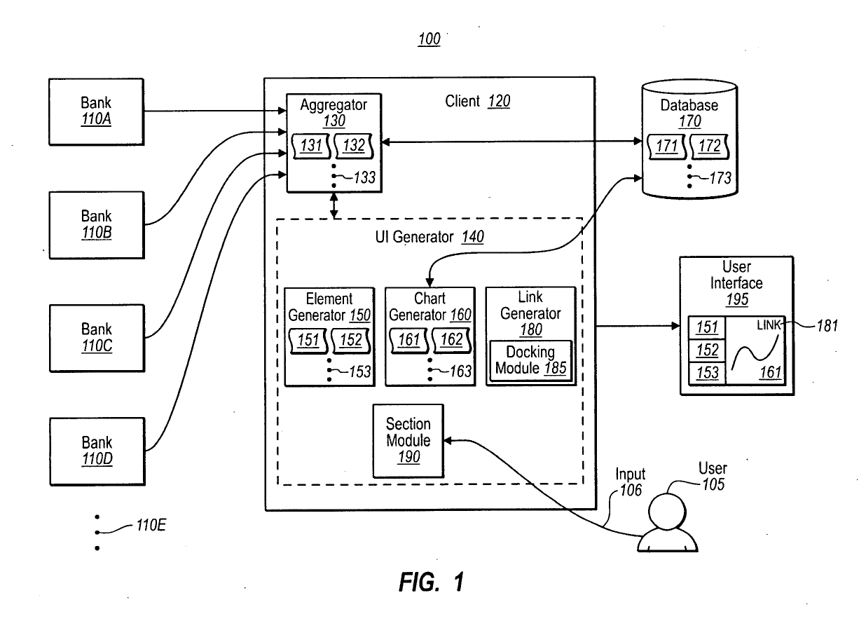

FIG. 1 illustrates an environment 100 in which embodiments disclosed herein may be practiced. It will be appreciated that the environment 100 is only one of numerous example environments in which the embodiments disclosed herein may be practiced. Accordingly, the environment 100 is shown by way of example only and should not be used to limit the scope of the appended claims.

As shown, environment 100 banks 110A, 110B, 100C, 110D, and potentially any additional number of banks as illustrated by ellipses 110E. The banks 110 may be government central banks, commercial banks, or any other financial institution that is authorized to price currency for buying and selling. As mentioned previously, currency can be traded in pairs so that there is a basis for an exchange rate between the currency pairs. Accordingly, the banks 110 specify a buy and sell price based on current market conditions for a given currency pair.

Environment 100 also includes a client 120 which may be a single server computer or which may be distrusted across multiple computing systems. The client 120 is configured to provide electronic trading tools for the (spot) FOREX retail market and provides various modules to help it provide the tools. It will be appreciated that the various modules of client 120 may be included in a single server computer or they may be distributed across multiple computing systems.

The client 120 includes an aggregation module 130, which is configured to aggregate price and liquidity and which may include software, hardware, or any combination of software and hardware as circumstances warrant. In operation, the aggregation module 130 receives the buy and sell prices from the various banks 110. The aggregation module 130 may then find the best sell price for a given currency pair from one bank and match that with the best buy price from another bank to generate a currency pair 131. The aggregation module 130 may then do the same to create currency pair 132 and potentially numerous currency pairs as illustrated by ellipses 133. The currency pairs 131, 132, and potentially 133 may be used by an electronic trading platform in the (spot) FOREX retail market as will be described in more detail to follow. In some embodiments, aggregation module 130 also adds a profit margin for the owner of client 120 into the buy and sell price of the currency pairs 131, 132, and 133.

For example, suppose the currency pair were US dollars and the EURO. Further suppose at first instance of time that bank 110A had the best sell price for this currency pair and bank 110B had the best buy price. The aggregation module 130 would take the sell price of bank 110A and the buy price of bank 110B and combine them into currency pair 131.

It should be noted that the buy and sell prices received from the banks 110 are constantly changing due to changes in the currency exchange market. In some instances, the prices change several times a second. Accordingly, the aggregation module 130 constantly updates the currency pairs 131, 132, and 133 that it creates so that these currency pairs include the best buy and sell price as discussed. For instance, using the example above, at a second instance of time, bank 110C may have the best sell price and bank 110A may have the best buy price. Accordingly, the aggregation module 130 would update currency pair 131 at the second instance of time to reflect the market changes. This process is constantly repeated anytime the FOREX market is active.

It should also be noted that price matching is often tied to liquidity. That is, when the banks 110 offer a price for a currency pair, the price is based on that banks liquidity in the currency pair. Accordingly, aggregation module may also aggregate liquidity for the banks 110 and then find the best price based on that liquidity.

The aggregation module 130 may provide the currency pairs to a user interface generator or module 140 of the client 120. The user interface generator 140, as well as any modules that may be included in interface generator 140, may include software, hardware, or any combination of software and hardware as circumstances warrant. In operation, the user interface generator 140 is configured to generate a user interface that may be used to buy and/or sell currency pairs in substantially real time. The user interface 140 may include various user interface elements that allow a trader to directly initiate the buy and sell transactions. The user interface 140 may also generate various charts or graphs that show historical trading data for the currency pairs. The charts or graphs may also include other information about the currency pairs that useful to a trader.

For example, the user interface generator 140 may include a currency pair user interface element generator or module 150. As mentioned the user interface generator 140 receives the currency pairs 131, 132, and 133 from the aggregation module 120. The user interface generator 140 may then generate one or more currency pair user interface elements 151, 152, and potentially any additional number of elements as illustrated by the ellipses 153 that correspond to the currency pairs 131, 132, and 133. In one embodiment, the currency pair user interface elements 151, 152, and 153 may be a widget (webified mini-application). The currency pair user interface elements 151, 152, and 153 may include real time data that is indicative of the current buy price and sell price of the currency pair. That is, as the buy and sell prices of the currency pairs 131, 132, and 133 are constantly updated, these prices are also constantly updated at the currency pair user interface elements. Thus, if a trader were viewing the currency pair user interface elements 151, 152, and 153, he or she would see that the buy and sell prices were constantly changing to reflect the real time price changes previously discussed.

In addition, the currency pair user interface elements 151, 152, and 153 may also include various buttons or similar elements that allow a trader to buy and/or sell the currency pair using the currency pair user interface elements. Accordingly, the trader does not need to use any other element of a trading platform to make buy and/or sell transactions. This allows the trader to use the currency pair user interface elements 151, 152, and 153 to buy and/or sell the currency pairs in substantially real time as the trader is able to initiate the transaction upon seeing the real time price he or she desires to buy or sell at. Specific embodiments of currency pair user interface elements will be described in more detail to follow.

The user interface generator 140 may also include a chart or graph generator or module 160. The chart generator 160 is configured to generate various charts or graphs 161, 162, and potentially any additional number charts as illustrated by ellipses 163. The charts 161, 162, and 163 each correspond to a specific currency pair and include historical trading data, typically in the form of a graph. The historical trading data may be used by the trader to determine price trends for the currency pair. As can be appreciated, such data may be helpful in determining if the current price information of a currency pair meets historical trends, which may in turn help the trader to know if he or she should buy or sell at a given point in time. The charts 161, 162, and 163 may also include other data or information relative to corresponding currency pair that may be useful to a trader.

As shown in FIG. 1, client 120 is associated with a database 170. The database 170, which may be any reasonable database, may be part of client 120 or it may be connected to the client. The database 170 receives or otherwise accesses the currency pairs from the aggregation module 130. The database 170 then stores this information as data 171, 172, and potentially any number of additional data as illustrated by ellipses 173. The stored data 171, 172, and 173 corresponds to a specific currency pair. This data is historical data as it reflects currency pair buy and sell prices that have already occurred. The chart generator 160 accesses the data 171, 172, and 173 for a specific currency pair when generating the chart 161, 162, or 163 for that specific currency pair as previously described.

As mentioned previously, traders often desire to include a currency pair user interface element such as elements 151, 152, and 153 with a corresponding chart 161, 162, or 163. Including the currency pair user interface elements with the corresponding chart allows the user to view both the real time data of the user interface element and the historical data of the chart. However, as also previously discussed, including the currency pair user interface element with the chart may cause problems if the currency pair user interface element is not docked with or tied to the chart. Accordingly, client 120 advantageously also includes a link generator or module 180. The link generator 180 is configured to generate one or more links at predefined locations in the 161, 162, or 163. The predefined locations may be in the upper or lower corners of the charts, although other locations are also contemplated.

The generated links are configured to dock a currency pair user interface element at the location of the link. That is, the link makes use of a docking module 185 that ties the currency pair user interface element to the chart, thus making the currency pair user interface element part of the chart. Thereafter, when a trader moves the chart with docked currency pair user interface element, the currency pair user interface element also moves. In this way, the real time price data and transaction capability of the currency pair user interface element remains with the historical data of the chart regardless of where in the user interface the trader places the chart. The trader is then able to buy and/or sell the currency pair corresponding to the currency pair user interface element and the chart without the need to view or access any other portion of the user interface

In some embodiments, the link generator 180 is able to determine the best location for the link based on the shape of the chart and place the link accordingly. For instance, in some embodiments the shape of the chart 161 may cover the upper or lower corners. As can be appreciated, docking a currency pair user interface element at the corners in such a situation may make it difficult for the trader to fully view the historical data. Accordingly, in some embodiments, the link generator 180 is able to generate the link at a location that maximizes the trader's viewing ability of the historical data. For example, if the shape of the chart 161 may cover the upper or lower corners, then perhaps the link generator 180 would place the link in the middle of the chart to maximize the viewing of the historical data.

The client 120 may also include a selection module 190 that is configured to allow a user 105 to select a currency pair user interface element such as element 151 for docking with a chart such as chart 161. For example, the selection module 190 receives user input 106 via a mouse, computer keyboard, or the like from the user 105. The user input may take several forms, specific examples of which will be explained in more detail to follow. The result of the user input 106 is that the selection module 190 selects a specific currency pair user interface element that is then docked to a corresponding chart.

In some embodiments, the selection module 190 or some other module of user interface generator 140 creates a copy of the selected currency pair user interface element. This copy will have the same functionality as the original and will also include real time data. The copy is then docked with the chart.

Referring again to FIG. 1, user interface 195 is shown. Although shown as separate from client 120, this is for ease of illustration only. It will be appreciated that user interface 195 typically is shown on a computer monitor or other display associated with client 120.

As shown, user interface 195 includes currency pair user interface elements 151, 152, and 153 grouped in a listing on a first portion of the user interface. This grouping is sometimes referred to as a “market watch” view. The user interface 195 also includes the chart 161, which corresponds to one of the currency pair user interface elements 151, 152, and 153 in a second portion of the user interface. As is further illustrated, a link 181 has been generated in the chart 161 at a predefined location by the user interface generator 140. As mentioned, a trader may select a specific a currency pair user interface element and use the link 181 to tie the selected currency pair user interface element to the chart 161.

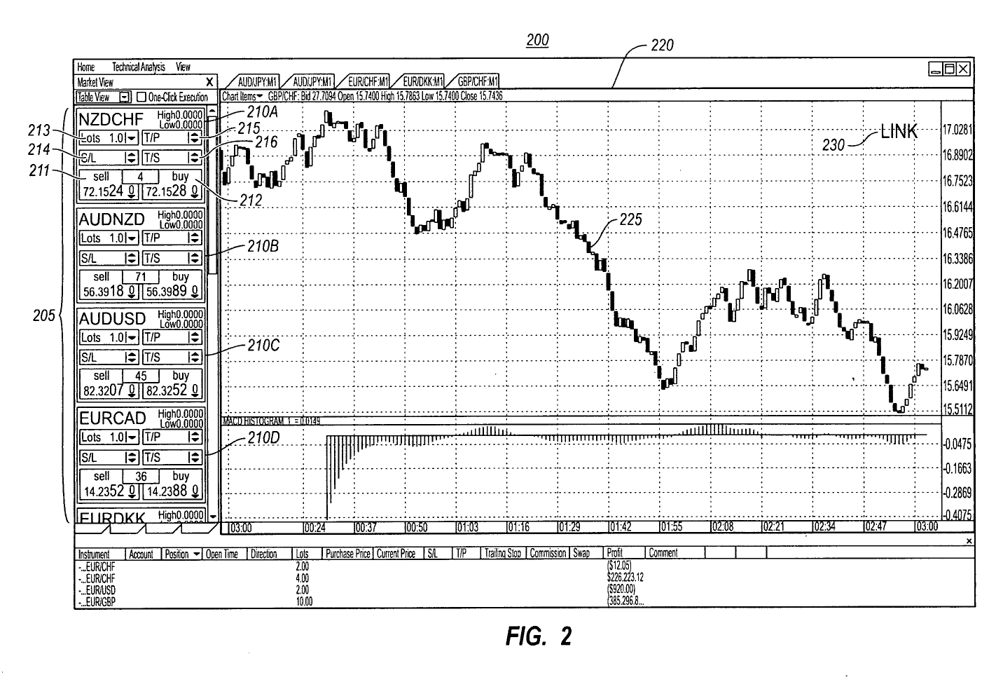

Turning now to FIG. 2, an example of a user interface 200, which may correspond to user interface 195, that has been generated by user interface generator 140 is illustrated and will be explained in more detail. As shown, the user interface 200 includes currency pair user interface elements 210A, 210B, 210C, 210D and 210E. These are grouped into a first portion or market view 205 of the user interface. Although five currency pair user interface elements are shown, it will be appreciated that user interface 200 may include any number of interfaces. Each currency pair user interface elements 210A, 210B, 210C, 210D and 210E corresponds to a specific currency pair as is shown. For example, currency pair user interface element 210C corresponds to an Australian dollar and U.S. dollar pair.

Each of the currency pair user interface elements 210A, 210B, 210C, 210D and 210E include various displays and buttons. For instance, using currency pair user interface element 210A as an example, the current sell price 211 and the current price 212 is shown. As previously mentioned, these values are constantly updated in real time, sometimes several times a second. Accordingly, when viewed by a trader the buy and sell values would be changing quite frequently and represent substantially real time data. These values may also include arrows that indicate if the sell or buy price is going up or down. The elements 211 and 212 may be used to buy or sell the currency pair as desired.

As further shown, the currency pair user interface elements may include further helpful tools that provide additional data for the trader. For instance button 213 allows a trader to specify a lot for buying or selling. A button 214 allows the trader to specify a stop loss value, while button 215 allows a trader to specify a take profit value. Button 216 allows the user to specify a trailing loss value. Each of these buttons and the data they help convey is configurable in the currency pair user interface itself

The user interface 200 also shows a second portion 220 that includes a chart 225. As mentioned, the chart 225 corresponds to one of the currency pairs shown in currency pair user interface elements 210. The chart 225 shows historical data about the corresponding currency pair in a line graph format. As shown, the line graph rises and falls in conjunction with changes in the buy and sell price of the currency pair. A time line along the bottom provides temporal content to the line graph. In this way, the user or trader is able to quickly determine the historical trends of the currency pair prices. The chart 225 also includes a link 230 for docking a currency pair user interface element.

Although the first portion of the user interface 205 and the second portion of the user interface 220 are shown in the same display or view, this need not be the case. In some embodiments, first portion 205 may be displayed in one computer monitor and the second portion 220 may be displayed in a different computer monitor. Thus, user interface 200, as well as the other user interface examples disclosed herein, may be distributed across multiple computer monitors or displays. As discussed previously, in recent years it has become common for a trader to utilize a large number of computer monitors when tracking multiple currency pairs.

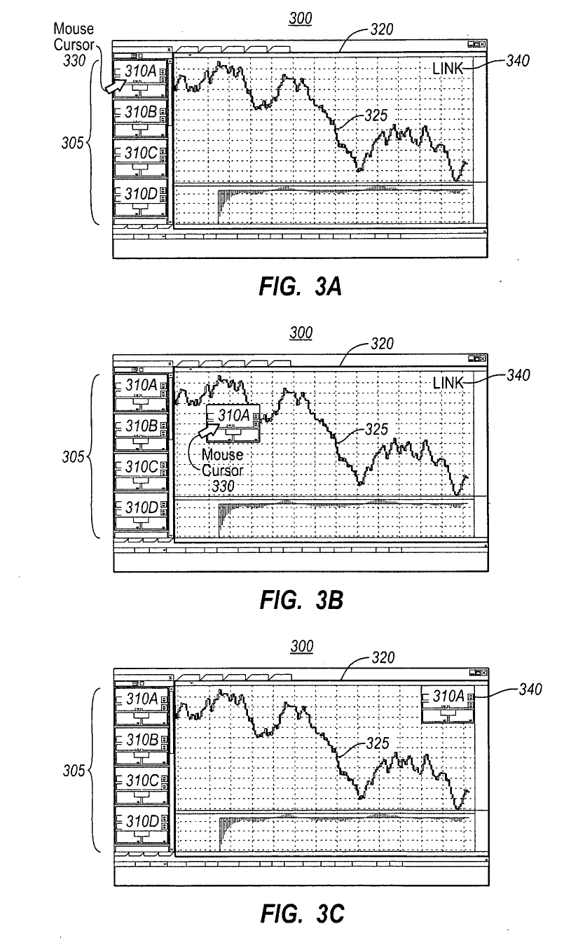

Attention is now given to FIGS. 3A-3C, which illustrate a specific embodiment of docketing a currency pair user interface element to a chart. FIGS. 3A-3C show a user interface 300. The user interface 300 includes currency pair user interface elements 310A, 310B, 310C, and 310D that are displayed at a first user interface portion 305. The currency pair user interface elements 310 correspond to the currency pair user interface elements 210 and thus need not be described in further detail.

The user interface 300 also includes a chart 325 that is displayed at a second user interface portion 320. The chart 325 corresponds to the chart 225 and need not be discussed in further detail. The chart 325 includes a link 340 that has been generated as described. The link 340 is configured to dock a currency pair user interface element to the chart 325.

Turing to FIG. 3A, a trader may provide user input to select the currency pair user interface element 310 that corresponds with the chart 325. In the illustrated embodiment, the trader places a computer mouse cursor 330 on currency pair user interface element 310 to select this user interface element. A copy of currency pair user interface 310A is then produced

As shown in FIG. 3B, the trader uses the mouse cursor 330 to drag the copy of currency pair user interface 310A from first portion 305 across chart 325 to the location of link 340.

As shown in FIG. 3C, the trader drops the copy of currency pair user interface 310A onto the link 340. The link 340 then docks the copy of currency pair user interface element 310A to the chart at the location of the link. As a result, the currency pair user interface element 310A is concurrently displayed in the first portion 305 and in the chart at the link location. Concurrently displaying the currency pair user interface 310A allows the trader to keep all the currency pair user interface elements in one location for quick access while still tying the currency pair user interface element to the chart.

As mentioned, the currency pair user interface element 310 that is displayed in the chart is tied to the chart. This means that when the chart is moved to other portions of the user interface such as another monitor the currency pair user interface element 310A remains a part of the chart at the location of link 340. Thus, the real time data for the currency pair moves with the historical data wherever the chart is moved within the user interface 300. Advantageously, this provides a way for the trader to view the real time buy and sell data and to actually initiate a buy and/or sell transaction without having to view or access any other part of the user interface. This is particularly useful in those embodiments were the user interface is distributed across multiple computer monitors.

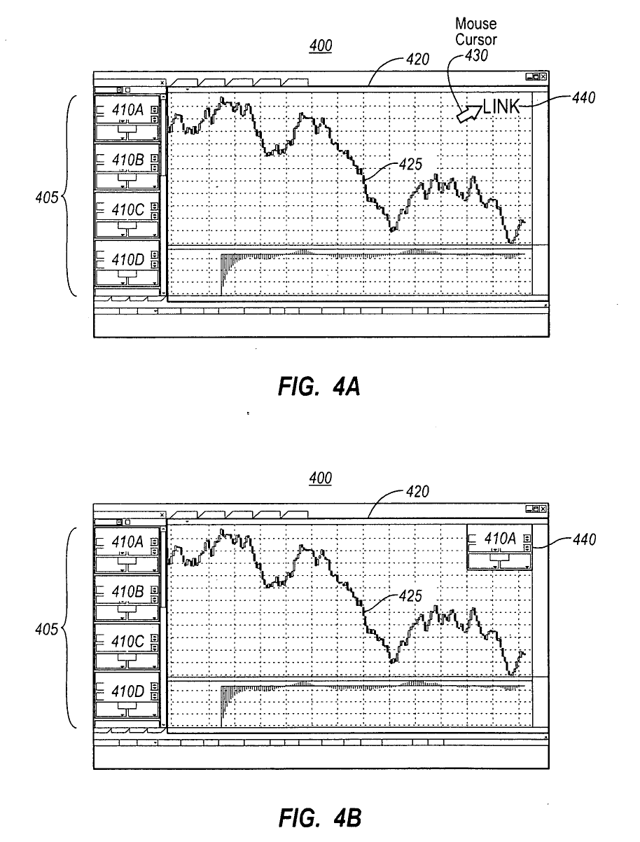

Attention is now given to FIGS. 4A-4B, which illustrate another embodiment of docketing a currency pair user interface element to a chart. FIGS. 4A-4B show a user interface 400. The user interface 400 includes currency pair user interface elements 410A, 410B, 410C, and 410D that are displayed at a first user interface portion 405. The currency pair user interface elements 410 correspond to the currency pair user interface elements 210 and thus need not be described in further detail.

The user interface 400 also includes a chart 425 that is displayed at a second user interface portion 420. The chart 425 corresponds to the chart 225 and need not be discussed in further detail. The chart 425 includes a link 440 that has been generated as described. The link 440 is configured to dock a currency pair user interface element to the chart 425.

Turing to FIG. 4A, a trader may provide user input to select the currency pair user interface element 410 that corresponds with the chart 425. In the illustrated embodiment, the trader clicks on or selects the link 440 with a computer mouse cursor 430. In this embodiment, the link 440 includes code that causes a copy of the desired currency pair user interface element to be created at the link 440.

As shown in FIG. 4B, the selected currency pair user interface element, which in this case is element 410B, is then automatically docked at the link 440. As a result, the currency pair user interface element 410A is concurrently displayed in the first portion 405 and in the chart at the link location. As mentioned, the currency pair user interface element 410A that is displayed in the chart is tied to the chart and moves with the chart as discussed previously in relation to FIGS. 3A-3C.

Although the above embodiments described docking a copy of the selected currency pair user interface element in the chart, this need not be the case. In some embodiments, a user or trader may desire to tie a currency pair user interface element to a chart for the advantageous reasons previously discussed without desiring to maintain the user interface element in a market watch view. In such embodiments, the currency pair user interface element may be docked to the chart as previously described without concurrently displaying the selected currency pair user interface as part of the market view in the first user interface portion.

In still other embodiments, the user or trader may simply desire to see the currency pair user interface element by itself In such embodiments, the user may minimize the chart and only display the currency pair user interface element.

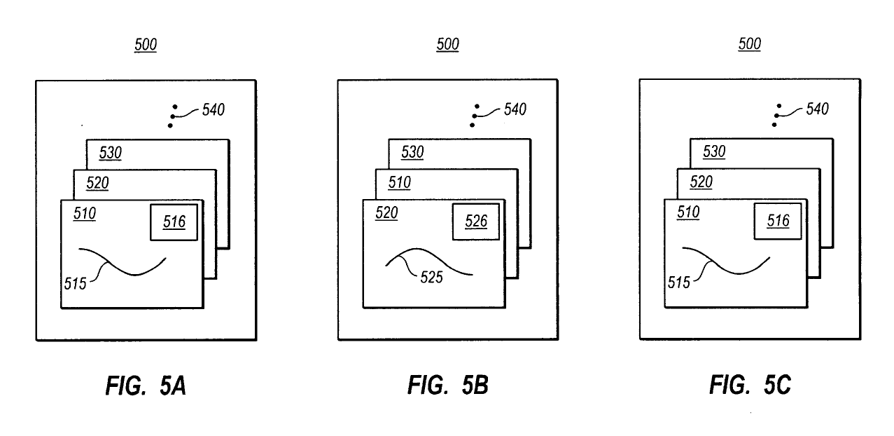

Attention is now made to FIGS. 5A-5C, which illustrate an embodiment of a user interface 500. In this embodiment the user interface 500, which may correspond to user interfaces 195 and 200 previously discussed, is shown in a single display such as a single monitor. In the display a stack of charts 510, 520, 530, and potentially any additional number as illustrated by ellipses 540 is shown. As shown in FIG. 5A, the chart 510 is on top of the stack and is the only chart visible. The chart 510 includes a line graph of historical data 515 and a currency pair user interface 516 that has been docked to the chart in the manner previously described. The currency pair user interface element 516 corresponds to those previously discussed.

In FIG. 5B, the chart 510 has been moved behind chart 520 in the display. As shown, the graph of historical data 525 and currency pair user interface element 526 of chart 520 are visible in the display. In FIG. 5C, the chart 510 has once again been moved to the top of the stack and graph 515 and currency pair user interface element 516 are again visible in the display.

FIGS. 5A-5C illustrate that currency pair user interface element 516 remains tied to chart 510 when the chart was moved lower in the stack. Thus, the currency pair user interface element 516 did not remain visible when the chart was moved. This is in sharp contrast to conventional trading platforms where the currency pair user interface element is left untied to the chart and thus does not move with the chart. If FIGS. 5A-5C were according to the conventional platforms, then currency pair user interface element 515 would have been visible along with currency pair user interface element 526 when chart 510 was moved lower in the stack. As can be appreciated, this would have been confusing for the trader.

However, the embodiments disclosed herein advantageously tie the currency pair user interface element to the chart. A trader may therefore move a chart or multiple charts numerous times in a stack of charts without having to worry about having multiple currency pair user interface elements cluttering the display.

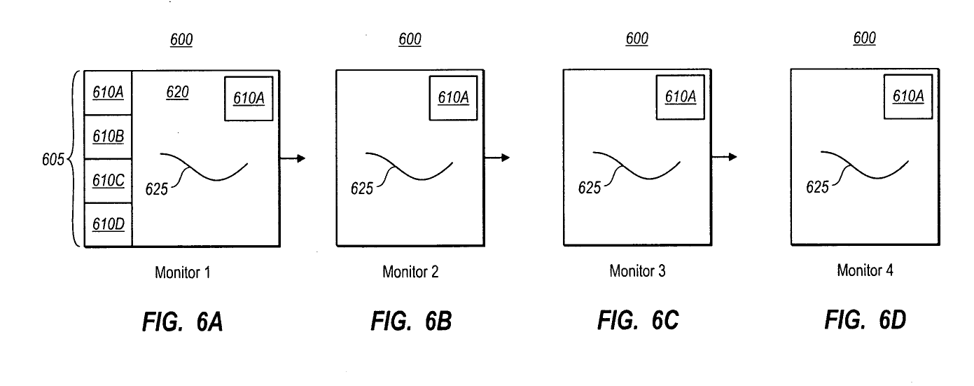

Turning now to FIGS. 6A-6D, an embodiment of a user interface 600, which may correspond to the user interfaces previously discussed, is shown. FIG. 6A shows currency pair user interface elements 610A-610D located in the first portion 605 of the user interface. A chart 625 that includes a corresponding docked currency pair user interface element 610A is located in a second portion 620 of the user interface. As shown, both the first and second portions of the user interface are located on a first monitor.

FIGS. 6B-6D illustrate that the chart 625 may be moved from the first monitor to a second monitor, from the second monitor to a third monitor, and from the third monitor to a fourth monitor. It will be appreciated that the chart 625 may be moved to several other monitors in systems that include more than four monitors.

As is further illustrated, when the chart 625 moves between monitors, the docked currency pair user interface element 610A remains with the chart. In particular, the real time buy and sell data of docked currency pair user interface element 610A moves with the historical data. As mentioned, this is an advantage over conventional trading platforms where the currency pair user interface element would not move with the chart across monitors. In that case, the trader would have to look back to the first monitor for the real the real time buy and sell data and might miss a desired price in the process.

Because the currency pair user interface element moves across monitors with the chart, a trader may buy and sell in substantially real time the currency pair using the currency pair user interface element. That is, the trader does not need to view or access the market view in the first monitor to buy and/or sell the currency pair. As discussed the currency pair user interface element includes the capability to perform these transactions.

As will be appreciated, this capability is a huge advantage in a system that includes multiple monitors since many of the monitors will of necessity be a distance from the first monitor that includes the market view. The trader simply could not efficiently buy and sell the currency pairs if he or she had to go back and forth between the monitors. However, the current embodiments allow the trader to focus on only one monitor as he or she may view the real time price data and perform the buy and sell transactions all in the same monitor because of the docked currency pair user interface element.

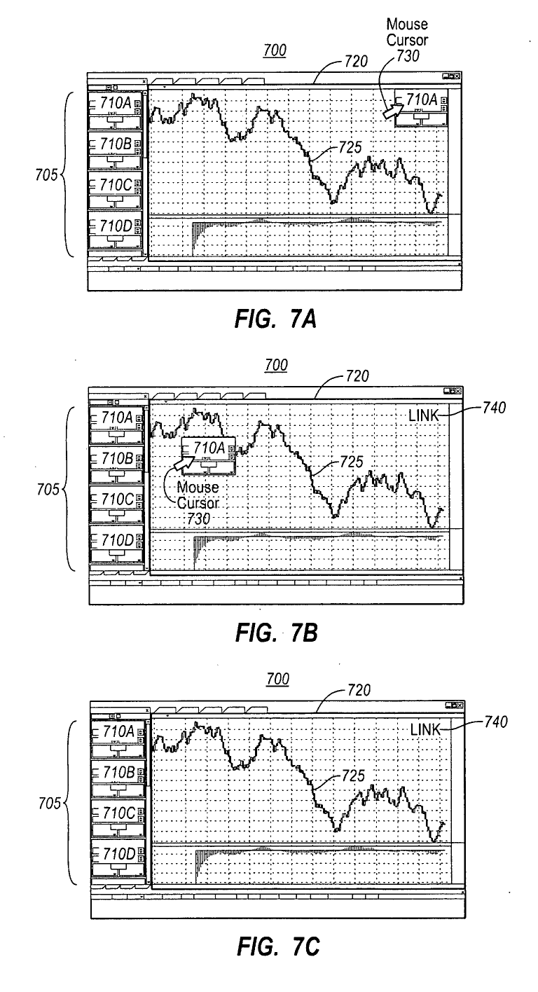

Attention is now given to FIGS. 7A-3C, which illustrate a specific embodiment of untying a currency pair user interface element from a chart. It will be appreciated, however, that this is only one of many different embodiments that may be used to untie the currency pair user interface from a chart.

FIGS. 7A-7C show a user interface 700. The user interface 700 includes currency pair user interface elements 710A, 710B, 710C, and 710D that are displayed at a first user interface portion 705. The currency pair user interface elements 710 correspond to the currency pair user interface elements 210 and thus need not be described in further detail.

The user interface 700 also includes a chart 725 that is displayed at a second user interface portion 720. The chart 725 corresponds to the chart 225 and need not be discussed in further detail. The chart 725 includes a currency pair user interface 710A that has been docked to the chart.

Turing to FIG. 7A, the trader places a computer mouse cursor 730 on currency pair user interface element 710A to select this user interface element. As shown in FIG. 3B, the trader uses the mouse cursor 730 to drag the currency pair user interface 710A from second portion 720, across chart 725 to the first portion 705.

As shown in FIG. 7C, the trader drops the currency pair user interface 710A onto the link the currency pair user interface 710A existing in the market view. In response, the currency pair user interface 710A is untied from the chart 725 as seen in FIG. 7C.

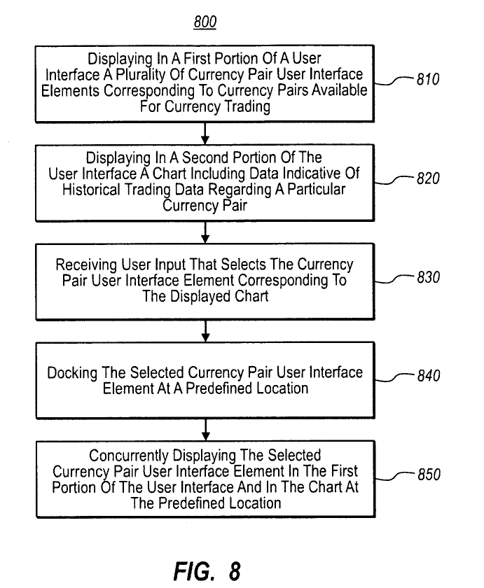

FIG. 8 illustrates a method 800 for customizing a user interface so that a currency pair user interface element is tied to a corresponding chart representing historical data for a currency pair. The user interface may be implemented in a computing system and may be distributed across one or more monitors. The method 800 will be described with reference to the environment described in relation to FIGS. 1-7, although this is by way of example only.

Method 800 include an act 810 of displaying in a first portion of a user interface a plurality of currency pair user interface elements corresponding to currency pairs available for currency trading. For example, the user interface generator 140, specifically element generator 150, may generate currency pair user interface elements 151, 152, and 153. As mentioned, the currency pair user interface elements include real time data indicative of current buy price and sell price for a corresponding currency pair. This real time data is received from aggregation module 130. The currency pair user interface elements are also configured such that a user may purchase or sell the corresponding currency pairs in substantially real time using the currency pair user interface elements. As discussed, the currency pair user interface elements may be displayed in the first portion 205 of the user interface as a market watch view.

The method 800 also includes an act 820 of displaying in a second portion of the user interface a chart including data indicative of historical trading data regarding a particular currency pair. For example, the user interface generator 140, specifically chart generator 160, may generate charts 161, 162, and 163. The charts may include historical trading data that is obtained from the database 170.

The charts 161, 162, and 163 may also include a link at one or more predefined locations. As mentioned, the link generator 180 generates the link 181. The link 181 is configured in conjunction with docking module 185 to dock the currency pair user interface elements 151, 152, and 153 to a corresponding chart.

The method 800 further includes an act 830 of receiving user input that selects the currency pair user interface element corresponding to the displayed chart. For example, the selection module 190 receives user input 106 from the user or trader 105. The input selects the currency pair user interface elements 151, 152, or 153 that corresponds to the displayed chart 161. In one embodiment, this act is performed as described above in relation to FIGS. 3A-3C. In another embodiment, this act is performed as described above in relation to FIGS. 4A-4B.

The method 800 additionally includes an act 840 of docking the selected currency pair user interface element at one of the predefined locations. For example, one of the currency pair user interface elements 151, 152, and 153 may be docked at the link 181 as previously described using selection module 190 and docking module 185.

In some embodiments, the method 800 includes, in response to the act of docking, an act 850 of concurrently displaying the selected currency pair user interface element in the first portion of the user interface and in the chart at the predefined location. For example, as illustrated in FIG. 3, the currency pair user interface element 310A in the first portion 305 is concurrently displayed with the currency pair user interface element 310A that has been docked to the chart 325. As discussed above, currently displaying the currency pair user interface element 310A provides various advantages over conventional trading platforms. In other embodiments, the selected currency pair user interface element may be displayed on the chart after being docked to the chart without concurrently displaying the currency pair user interface element in the market watch view.

As also discussed, the currency pair user interface element displayed in the chart is tied to the chart. Accordingly, when the chart is moved to other portions of the user interface the currency pair user interface element remains a part of the chart at the predefined location so that the real time data for the currency pair moves with the historical data wherever the chart is moved within the user interface. This provides various advantages over conventional trading platforms as discussed.

In further embodiments, the method 800 may also include an act of moving the chart with the docked currency pair user interface element from a first computer monitor to a second computer monitor that is different from the first computer monitor. As mentioned, the real time data for the currency pair moves with the historical data when the chart is moved. In addition, the method may include an act of using the currency pair user interface element that is docked with the chart to buy and/or sell the currency pair in substantially real time without the need to view or access the plurality of currency pair user interface elements displayed at the first computer monitor.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

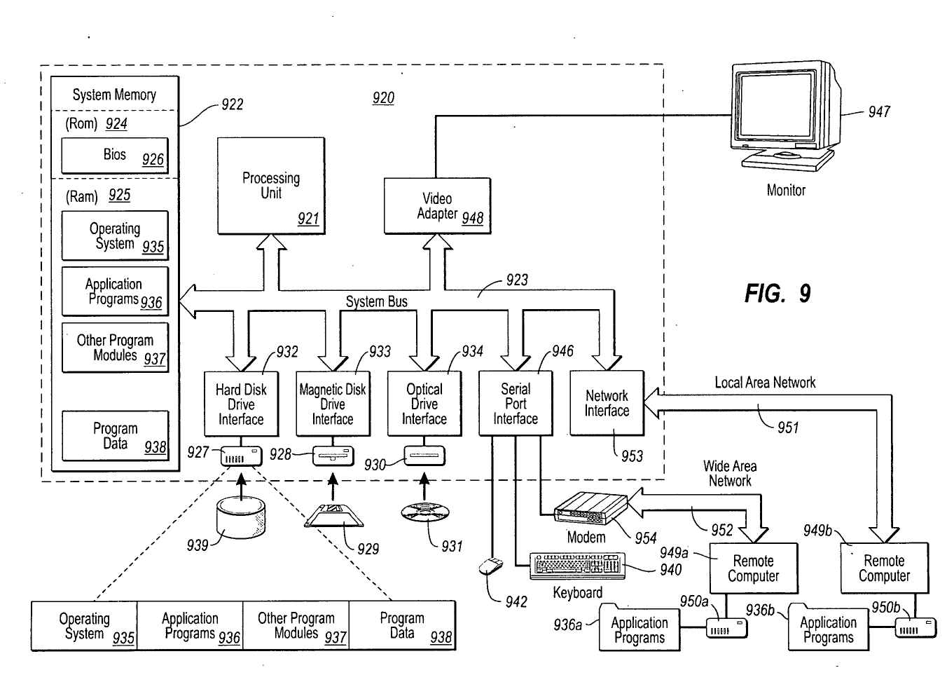

FIG. 9 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 9, an example system for implementing the invention includes a general purpose computing device in the form of a conventional computer 920, including a processing unit 921, a system memory 922, and a system bus 923 that couples various system components including the system memory 922 to the processing unit 921. It should be noted however, that as mobile phones become more sophisticated, they are beginning to incorporate many of the components illustrated for conventional computer 920. Accordingly, with relatively minor adjustments, mostly with respect to input/output devices, the description of conventional computer 920 applies equally to mobile phones. The system bus 923 may be any of several types of bus structures including a memory bus or memory controller, a peripheral bus, and a local bus using any of a variety of bus architectures. The system memory includes read only memory (ROM) 924 and random access memory (RAM) 925. A basic input/output system (BIOS) 926, containing the basic routines that help transfer information between elements within the computer 920, such as during start-up, may be stored in ROM 924.

The computer 920 may also include a magnetic hard disk drive 927 for reading from and writing to a magnetic hard disk 939, a magnetic disk drive 928 for reading from or writing to a removable magnetic disk 929, and an optical disc drive 30 for reading from or writing to removable optical disc 931 such as a CD-ROM or other optical media. The magnetic hard disk drive 927, magnetic disk drive 928, and optical disc drive 930 are connected to the system bus 923 by a hard disk drive interface 932, a magnetic disk drive-interface 933, and an optical drive interface 934, respectively. The drives and their associated computer-readable media provide nonvolatile storage of computer-executable instructions, data structures, program modules and other data for the computer 920. Although the exemplary environment described herein employs a magnetic hard disk 939, a removable magnetic disk 929 and a removable optical disc 931, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 939, magnetic disk 929, optical disc 931, ROM 924 or RAM 925, including an operating system 935, one or more application programs 936, other program modules 937, and program data 938. A user may enter commands and information into the computer 920 through keyboard 940, pointing device 942, or other input devices (not shown), such as a microphone, joy stick, game pad, satellite dish, scanner, or the like. These and other input devices are often connected to the processing unit 921 through a serial port interface 946 coupled to system bus 923. Alternatively, the input devices may be connected by other interfaces, such as a parallel port, a game port or a universal serial bus (USB). A monitor 947 or another display device is also connected to system bus 923 via an interface, such as video adapter 948. In addition to the monitor, personal computers typically include other peripheral output devices (not shown), such as speakers and printers.

The computer 920 may operate in a networked environment using logical connections to one or more remote computers, such as remote computers 949a and 949b. Remote computers 949a and 949b may each be another personal computer, a server, a router, a network PC, a peer device or other common network node, and typically include many or all of the elements described above relative to the computer 920, although only memory storage devices 950a and 950b and their associated application programs 936a and 936b have been illustrated in FIG. 9. The logical connections depicted in FIG. 9 include a local area network (LAN) 951 and a wide area network (WAN) 952 that are presented here by way of example and not limitation. Such networking environments are commonplace in office-wide or enterprise-wide computer networks, intranets and the Internet.

When used in a LAN networking environment, the computer 920 is connected to the local network 951 through a network interface or adapter 953. When used in a WAN networking environment, the computer 920 may include a modem 954, a wireless link, or other means for establishing communications over the wide area network 952, such as the Internet. The modem 954, which may be internal or external, is connected to the system bus 923 via the serial port interface 946. In a networked environment, program modules depicted relative to the computer 920, or portions thereof, may be stored in the remote memory storage device. It will be appreciated that the network connections shown are exemplary and other means of establishing communications over wide area network 952 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computer system comprising a user interface distributed across one or more computer monitors, a method for customizing the user interface so that a currency pair user interface element is tied to a corresponding chart representing historical data for a currency pair, the method comprising:
an act of displaying in a first portion of a user interface a plurality of currency pair user interface elements corresponding to currency pairs available for currency trading, wherein each of the plurality of currency pair user interface elements include real time data indicative of current buy price and sell price for a corresponding currency pair and wherein each of the plurality of currency pair user interface elements are configured such that a user may purchase or sell the corresponding currency pairs in substantially real time using the currency pair user interface elements;
an act of displaying in a second portion of the user interface a chart including data indicative of historical trading data regarding a particular currency pair, the chart including one or more predefined locations including a link configured to dock the currency pair user interface element corresponding to the particular one currency pair to the chart;
an act of receiving user input that selects the currency pair user interface element corresponding to the displayed chart;
an act of docking the selected currency pair user interface element at one of the predefined locations; and
in response to docking, an act of concurrently displaying the selected currency pair user interface element in the first portion of the user interface and in the chart at the predefined location, wherein the currency pair user interface element displayed in the chart is tied to the chart such that when the chart is moved to other portions of the user interface the currency pair user interface element remains a part of the chart at the predefined location such that the real time data for the currency pair moves with the historical data wherever the chart is moved within the user interface.

2. The method in accordance with claim 1, wherein the first and second portion of the user interface are displayed in a first monitor of the computing system, wherein moving the chart from the second portion of the user interface to another portion of the user interface comprises:
an act of displaying the chart in a second computer monitor that is different from the first computer monitor.

3. The method in accordance with claim 1, wherein the chart is a first chart, wherein moving the chart from the second portion of the user interface to another portion of the user interface comprises:
an act of placing the first chart behind a second chart in a display window.

4. The method in accordance with claim 1, wherein the act of receiving user input that selects the currency pair user interface element corresponding to the displayed chart comprises:
an act of dragging the selected currency pair user interface element from the first portion of the user interface to one of the predefined locations;
an act of dropping the selected currency pair user interface element onto the link at the predefined location; and
in response, an act of the link docking the selected currency pair user interface element to the chart at the predefined location.

5. The method in accordance with claim 1, wherein the act of receiving user input that selects the currency pair user interface element corresponding to the displayed chart comprises:
an act of selecting the link, wherein the link is configured to cause the currency pair user interface element corresponding to the chart to be docked at the link; and
in response, an act of the link docking the selected currency pair user interface element to the chart at the predefined location.

6. The method in accordance to claim 1, wherein the currency pair user interface elements are configurable by a user and wherein the currency pair user interface elements further include additional currency trading data including stop-loss data, lots data, take profit data, and trailing loss data.

7. The method in accordance with claim 1, further comprising:
an act of receiving user input that undocks the currency pair user interface element from the chart such that the currency pair user interface element is no longer displayed as part of the chart.

8. In a computer system comprising a user interface distributed across one or more computer monitors, the user interface configured to display one or more currency pair user interface elements corresponding to a currency pair available for currency trading and one or more charts corresponding to the currency pairs, wherein the currency pair user interface elements include real time data indicative of a current buy price and a sell price for a corresponding currency pair and wherein each of the plurality of currency pair user interface elements are configured such that a user may purchase or sell the corresponding currency pairs in substantially real time using the currency pair user interface elements, and wherein the one or more charts display data indicative of historical trading patterns and/or other trading data regarding a particular currency pair, a method for customizing the user interface so that a particular currency pair user interface element is tied a corresponding chart, the method comprising:
an act of selecting a currency pair user interface element from a listing that includes a plurality of currency pair user interface elements, the selected currency pair user interface element corresponding to an chart associated with the currency pair of the currency pair user interface element;
an act of docking the selected currency pair user interface element at a predefined location of the chart, the predefined location including a link configured to dock the currency pair user interface element to the chart; and
an act of displaying the currency user interface element at the predefined location of the chart, the currency pair user interface element being docked to the chart such that the currency user interface element becomes part of the chart such that when the chart is moved to other portions of the user interface the currency pair user interface element remains a part of the chart at the predefined location such that the real time data for the currency pair moves with the historical data wherever the chart is moved within the user interface.

9. The method in accordance with claim 8, further comprising:
an act of undocking the currency pair user interface element from the chart such that the currency pair user interface element is no longer displayed as part of the chart.

10. The method in accordance with claim 8, wherein the chart is displayed in a first computer monitor, the method further comprising:
an act of moving the chart to a second computer monitor that is different from the first computer monitor, wherein the currency pair user interface element remains part of the chart when the chart is moved to the second computer monitor.

11. The method in accordance with claim 8, wherein the chart is a first chart, the method further comprising:
an act of placing the first chart behind a second chart in a display window, wherein the currency pair user interface element remains part of the first chart when the first chart is placed behind the second chart.

12. The method in accordance with claim 8, wherein the act of selecting at the computer system a first currency pair user interface element comprises:
an act of dragging the selected currency pair user interface element from the first portion of the user interface to one of the predefined locations;
an act of dropping the selected currency pair user interface element onto the link at the predefined location; and
in response, an act of the link docking the selected currency pair user interface element to the chart at the predefined location.

13. The method in accordance with claim 8, wherein the act of selecting at the computer system a first currency pair user interface element comprises:
an act of selecting the link, wherein the link is configured to cause the currency pair user interface element corresponding to the chart to be docked at the link; and
in response, an act of the link docking the selected currency pair user interface element to the chart at the predefined location.

14. The method in accordance to claim 8, wherein the currency pair user interface elements are configurable by a user and wherein the currency pair user interface elements further include additional currency trading data including stop-loss data, lots data, take profit data, and trailing loss data.

15. A computing system comprising:
a module configured to generate one or more currency pair user interface elements, the currency pair user interface elements corresponding to currency pairs available for trading, wherein the currency pair user interface elements include at least real time data indicative of a current buy price and a sell price for a corresponding currency pair and wherein each of the plurality of currency pair user interface elements are configured such that a user may purchase or sell the corresponding currency pairs in substantially real time using the currency pair user interface elements;
a module configured to generate one or more charts, wherein the one or more charts display data indicative of historical trading patterns and/or other trading data regarding a particular currency pair;
a module configured to generate one or more links at a predefined location on the one or more charts, the generated links configured to tie a currency pair user interface element to a chart;
a module configured to select a particular currency pair user interface element for inclusion in a chart corresponding to the selected currency pair user interface element;
a module configured to dock the selected currency pair user interface element at the predefined location to the chart such that the selected currency user interface element is tied to the chart; and
a user interface configured to display the selected currency pair user interface element as a part of the chart.

16. The system in accordance with claim 15, further comprising:
a module configured to undock the currency pair user interface element from the chart such that the currency pair user interface element is no longer displayed as part of the chart.

17. The system in accordance with claim 15, wherein when the chart and the docked currency pair user interface element are moved from a first monitor of the computing system to a second monitor of the computing system the currency pair user interface element remains tied to the chart.

18. The system in accordance with claim 15, wherein when the chart and the tied currency pair user interface element are moved behind another chart in a display window, the currency pair user interface element remains tied to the chart.

19. The system in accordance with claim 15, wherein the selection module selects the currency pair user interface element by dragging a selected currency pair user interface element from the listing of currency pair user interface elements to the chart.

20. The method in accordance with claim 15, wherein the selection module selects the currency pair user interface element by selecting the link, where the link is configured to cause the currency pair user interface element corresponding to the chart containing the link to be docked at the link.

21. A computer program product comprising one or more physical computer-readable media having thereon computer-executable instructions that are structured such that, when executed by one or more processors of a computing system including a user interface configured to display currency pair user interface elements, the computing system is caused to perform a method for customizing the user interface so that a currency pair user interface element is tied a corresponding chart, the method comprising:
an act of displaying in a first portion of a user interface a plurality of currency pair user interface elements corresponding to currency pairs available for currency trading, wherein each of the plurality of currency pair user interface elements include real time data indicative of current buy price and sell price for a corresponding currency pair and wherein each of the plurality of currency pair user interface elements are configured such that a user may purchase or sell the corresponding currency pairs in substantially real time using the currency pair user interface elements;
an act of displaying in a second portion of the user interface a chart including data indicative of historical trading data regarding a particular currency pair, the chart including one or more predefined locations including a link configured to dock the currency pair user interface element corresponding to the particular one currency pair to the chart;
an act of receiving user input that selects the currency pair user interface element corresponding to the displayed chart;
an act of docking the selected currency pair user interface element at one of the predefined locations; and
in response to docking, an act of concurrently displaying the selected currency pair user interface element in the first portion of the user interface and in the chart at the predefined location, wherein the currency pair user interface element displayed in the chart is tied to the chart such that when the chart is moved to other portions of the user interface the currency pair user interface element remains a part of the chart at the predefined location such that the real time data for the currency pair moves with the historical data wherever the chart is moved within the user interface.

22. In a computer system comprising a user interface distributed across a plurality of computer monitors, a method for customizing the user interface so that a currency pair user interface element is tied to a corresponding chart representing historical data for a currency pair, the method comprising:
an act of displaying a plurality of currency pair user interface elements corresponding to currency pairs available for currency trading, wherein each of the plurality of currency pair user interface elements include real time data indicative of current buy price and sell price for a corresponding currency pair and wherein each of the plurality of currency pair user interface elements are configured such that a user may purchase or sell the corresponding currency pairs in substantially real time using the currency pair user interface elements;
an act of displaying in a chart including data indicative of historical trading data regarding a particular currency pair, the chart including one or more predefined locations including a link configured to dock the currency pair user interface element corresponding to the particular one currency pair to the chart, wherein the plurality of currency pair user interface elements and the chart are displayed at a first computer monitor;
an act of receiving user input that selects the currency pair user interface element corresponding to the displayed chart;
an act of docking the selected currency pair user interface element at one of the predefined locations;
in response to docking, an act of displaying the selected currency pair user interface element in the chart such that the selected currency pair user interface element is tied to the chart;
an act of moving the chart from the first computer monitor to a second computer monitor that is different from the first computer monitor, wherein the real time data for the currency pair moves with the historical data when the chart is moved; and
an act of using the currency pair user interface element that is docked with the chart to buy and/or sell the currency pair in substantially real time without the need to view or access the plurality of currency pair user interface elements displayed at the first computer monitor.

23. The method in accordance with claim 22, wherein the display of the plurality of currency pair user interface elements is a market watch view.

24. The method in accordance with claim 22, wherein using the currency pair user interface element that is docked with the chart to buy and/or sell the currency pair in substantially real time comprises:
using one or more preset conditions that are configurable in the currency pair user interface element.

25. The method in accordance with claim 24, wherein the preset conditions are one of stop-loss, lots, take profit, and trailing loss.
